(19) United States
(12) Patent Application Publication
(10) Pub. No.: US 2023/0056008 A1
(43) Pub. Date: Feb. 23, 2023

(54) SUPPORT FOR ATTACHMENT TO A STRUCTURAL MEMBER

(71) Applicant: Bowyer John, Kelso QLD (AU)

(72) Inventor: Bowyer John, Kelso QLD (AU)

(21) Appl. No.: 17/408,516

(22) Filed: Aug. 23, 2021

(51) Int. Cl. F16M 13/02

(52) U.S. Cl. CPC F16M 13/02

(57) ABSTRACT

A support for attachment to a structural member comprising, the support comprising a pair of side members; a receiving portion located in each of the pair of side members configured to receive a portion of the structural member; and an end member, wherein the end member includes a connection portion configured to facilitate connection of the end member to an adjacent support, and wherein at least one of the pair of side members comprises a connection portion configured to facilitate connection of a utility object thereto.

### TECHNICAL FIELD

The present invention relates to a support for attachment to a structural member. More particularly, the present invention relates to a support for attachment to a structural member to support an object such as a pipe.

### BACKGROUND ART

Construction of a building or the refitting of a workspace within a building such as an office or factory requires the fitting of structural members such as an I-beam, channel member (or ‘C-shaped’ member) or angle iron (or ‘L-shaped’ member) to support the structure of the building and then install secondary infrastructure in the form of utility objects such as water, sewage or compressed air pipes, electrical wiring or cables and the installation of light fittings.

Typically the secondary infrastructure is then installed into an interior space of the building by permanently welding secondary supports, such as pipe supports or electrical wiring brackets to the structural members or drilling holes in the structural member which can be difficult in itself. This process can be time consuming requiring specialist skilled welders to complete the welding which can delay the installation process and increase the cost of construction. In addition, re-fitting the interior space is also difficult and time-consuming as it requires the dismantling of welds.

It will be clearly understood that, if a prior art publication is referred to herein; this reference does not constitute an admission that the publication forms part of the common general knowledge in the art in Australia or in any other country.

### SUMMARY OF INVENTION

The present invention is to directed to a support for attachment to a structural member which may at least partially overcome at least one of the aforementioned disadvantages or provide the consumer with a useful or commercial advantage.

With the foregoing in view, the present invention in a first aspect, resides broadly in a support for attachment to a structural member comprising, the support comprising:
a pair of side members;
a receiving portion located in each of the pair of side members configured to receive a portion of the structural member; and
an end member, wherein the end member includes a connection portion configured to facilitate connection of the end member to an adjacent support,
   and wherein at least one of the pair of side members comprises a connection portion configured to facilitate connection of a utility object thereto.

The support for attachment to a structural member may be of any suitable size, shape, or configuration. However, it is envisaged that the support may be of sufficient size and shape so as to facilitate the attachment (and preferably retention) of a utility object to the support. In this way, the utility object may be retained in close proximity to, or abutment with, the structural member.

One or more supports may be used. The one or more supports may be the same type of support, or, alternatively, the one or more supports may be of different types. It will be understood that the type of support may vary depending on a number of factors such as the type of structural member, the location of the structural member, the type of utility object and the number of utility objects.

The support may be adapted for attachment to any suitable structural member. For instance, the structural member may be an I-beam, a C-shaped channel member, an L-shaped angle iron, or the like.

The support may be attached to the structural member by any suitable means. For instance, the supports may be attached to the structural member using one or more mechanical fasteners (such as screws, bolts, rivets, pins, or the like), an adhesive, a heat or chemical treatment, or welded using any suitable technique. Alternatively, the supports and the structural member may be fastened together by frictional engagement, or by providing complementary screw-threaded portions, press fittings, snap fit features, male-female connectors, or the like. Preferably, the support and the structural member may be connected to one another by frictional engagement.

The adjacent support may be of any suitable type. In some embodiments, the adjacent support may be substantially identical to the support. In these embodiments of the invention, the adjacent support may also be adapted to receive a portion of the structural member. It is envisaged that the portion of the structural member received in the adjacent support may be different to the portion of the structural member received in the support. For instance, the support and the adjacent support may be adapted to receive opposed flanges of a structural member, such as an I-beam, C-shaped channel member, an L-shaped angle iron or the like.

In other embodiments, the adjacent support may be different to the support. In these embodiments, the adjacent support may be adapted to overlie, for instance, a web of a structural member, such as an I-beam, C-shaped channel member, an L-shaped angle iron or the like. Thus, in this embodiment, the adjacent support may not receive a portion of the structural member, and therefore may not be provided with receiving portions. Instead, it is envisaged that the adjacent support may be provided with at least a pair of side members and an end member. It is envisaged that the end member of the adjacent support may be adapted for connection to the end member of the support. It is further envisaged that at least one of the side members of the adjacent support may include a connection portion configured to facilitate connection of a utility object thereto.

The pair of side members and the end member of the adjacent support may be formed integrally with one another, or may be formed separately and adapted for fixed or removable connection thereto. In some embodiments, the adjacent support may be in the form of a substantially C- or U-shaped channel.

The support for attachment to a structural member comprises a pair of side members. The pair of side members may be located in any suitable orientation relative to one another in use. Preferably, however, a first of the pair of side members and a second of the pair of side member may be positioned substantially parallel to one another in use. The side members may be of any suitable size, shape, or configuration. However, it is envisaged that the side members may be of sufficient size and shape so as to facilitate the attachment of a utility object thereto.

Preferably, each of the pair of side members is of substantially the same size, shape and configuration. However, it is envisaged that, in some embodiments of the invention, the pair of side members may be of different size, shape and configuration to one another.

The pair of side members may be formed integrally with one another. In this embodiment, it is envisaged that one or more interconnecting members may extend between the pair of side members so as to connect the pair of side members to one another. Alternatively, the pair of side members may be formed integrally with the end member. In other embodiments of the invention, the pair of side members (and the end member) may be formed separately from one another and adapted for fixed or temporary connection to one another.

The side members may be fabricated from any suitable material. For instance, the side members may be fabricated from a metal or metal alloy (such as, but not limited to, aluminium, brass, steel, zinc-plate steel, stainless steel, and the like), a relatively durable polymeric material (such as, but not limited to, polycarbonate, polyethylene, polypropylene, polystyrene, polyvinyl chloride, acrylonitrile butadiene styrene and the like, or any suitable combination thereof), or any suitable combination thereof. In an embodiment of the invention, the side members may be fabricated from a metal or metal alloy. In an embodiment of the invention, the pair of side members may be fabricated from 6 mm metal plate.

Preferably, at least one of the pair of side members may include one or more apertures in a surface thereof. In an embodiment of the invention, each of the pair of side members may include one or more apertures in a surface thereof. Preferably, the apertures may be spaced along the surface of the side member(s). In use, it is envisaged that the one or more apertures may be used to facilitate the attachment of the utility object to the support or to facilitate the bracing of the pair of side members of the support (for instance, by locating a brace member in the apertures to extend between the pair of side members).

The apertures may be of any suitable shape, size or configuration. However, it will be understood that the shape and size of the apertures may vary depending on a number of factors such as the type of mechanical fasteners to be used to attach the utility object to the support, the type and number of utility objects to be attached, the characteristics of the utility object, and the degree of bracing required. In an embodiment of the invention, each side member of the pair of side members comprises the same number of apertures. In an alternative embodiment of the invention, each side member of the pair of side members comprises a different number of apertures. In an embodiment of the invention, the apertures in the first side member substantially align with the apertures in the second side member.

In an embodiment of the invention, the first of the pair of side members and the second of the pair of side members may be connected by one or more mechanical fasteners, one or more brace members, a wall member, or the like.

In a preferred embodiment of the invention, the first side member and the second side member may be connected by at least one end member. The end member may be of any suitable configuration, for instance, the end member may be a side member, a lower member, an upper member, etc. In this way, the end member may assist in stabilising the support by bracing the pair of side members such that the pair of side members may be substantially precluded from movement relative to one another. The pair of side members may be connected to the end member by any suitable means. For instance, the pair of side members may be connected to the end member using one or more mechanical fasteners (such as screws, bolts, rivets, pins, or the like), an adhesive, a heat or chemical treatment, or welded using any suitable technique. Alternatively, the pair of side members and the end member may be fastened together by frictional engagement, or by providing complementary screw-threaded portions, press fittings, snap fit features, male-female connectors, or the like.

Alternatively, the pair of side members may be secured in place relative to each other by one or more fasteners, such as mechanical fasteners. In use, the one or more fasteners may be passed through an aperture in one member of the pair of side members and through a corresponding aperture in the second member of the pair of side members. Any suitable fastener may be used. For instance, the fastener may comprise a pin (such as a support pin, lynch pin, spigot pin, etc.), bolt (such as a threaded bolt, through bolt, etc.), screw (such as a lag screw, structural screw, etc.) or the like.

The support comprises at least one receiving portion configured to receive a portion of the structural member. In an embodiment of the invention, each side member of the support comprises a receiving portion. In an embodiment of the invention, the receiving portion may be shaped such that it at least partially retains a portion of the structural member. The portion of the structural member may be of any suitable type, although it is envisaged that the portion of the structural member may be a flange of a structural member, a web of a structural member, or an end of a structural member. It is envisaged that the portion of the structural member may be retained in the receiving portion of the support in a frictional engagement therewith. It is envisaged that in use, the portion of the structural member may be at least partially retained by a surface of the receiving portion of the support.

The receiving portion may be any suitable shape. However it will be understood that the shape of the receiving portion may vary depending on a number of factors, such as the shape and size of the portion of the structural member and the characteristics of the utility object. The receiving portion may extend inwardly into the side member from an edge thereof. In this embodiment the receiving portion may comprise a slot, a channel, a recess, or the like within the side member. Preferably, the receiving portion is substantially linear and is of sufficient length to at least partially receive and retain the portion of the structural member.

The receiving portion may comprise a lining. It is envisaged that the lining may electrically insulate the support from the structural member. It is envisaged that the lining may aid in retaining the support in connection with the structural member.

The support for attachment to a structural member comprises an end member. The end member may be any suitable shape, size or configuration. For instance, the end member may be substantially planar, may be curved or may comprise two or more portions extending at any suitable angle from one another. However, it will be understood that the shape and size of the end member may vary depending on a number of factors, such as the type of structural member and the type of side members. It is envisaged that, in use, the end member of a support may abut, or be located in close proximity to, the end member of an adjacent support in use. In an embodiment of the invention, a portion of the end member of the support may at least partially extend into the receiving portion of the support. In this instance, a portion of the end member may abut the portion of the structural member retained by the receiving portion of the support.

The end member may be a unitary structure. In an alternative embodiment of the invention, the end member may be formed from two or more portions, wherein the two or more portions are fastened together to form a composite structure. The two or more portions may be fastened together using one or more mechanical fasteners (screws, bolts, rivets, pins, or the like), an adhesive, a heat or chemical treatment, or welded using any suitable technique. Alternatively, the two or more portions may be fastened together by frictional engagement, or by providing complementary screw-threaded portions, press fittings, snap fit features, male-female connectors, or the like.

The end member may be fabricated from any suitable material. For instance, the end members may be fabricated from a metal or metal alloy (such as aluminium, brass, steel, zinc-plate steel, stainless steel, or the like), a relatively durable polymeric material (such as, but not limited to, polycarbonate, polyethylene, polypropylene, polystyrene, polyvinyl chloride, acrylonitrile butadiene styrene and the like, or any suitable combination thereof), or any suitable combination thereof. In an embodiment of the invention, the end members may be fabricated from a metal or metal alloy. In an embodiment of the invention, the end member may be fabricated from 6 mm metal plate.

The side members and the end member may be fabricated from the same type of material. Alternatively, the side members and the end member may be fabricated from different types of material. In an embodiment of the invention the end member may be electrically insulated from the side members.

The end member of the support may include a connection portion to facilitate connection of the end member to an adjacent support. In an embodiment of the invention, the end member of the support may include a connection portion to facilitate connection of the end member to the structural member. In a yet further embodiment of the invention, the end member of the support may include a connection portion to facilitate connection of the end member to an adjacent support and the structural member.

The end member of the support may be connected to the structural member and/or an adjacent support by any suitable means. For instance, the end member of the support may be connected to the structural member and/or an adjacent support using one or more mechanical fasteners (such as screws, bolts, rivets, pins, or the like), an adhesive, a heat or chemical treatment, or welded using any suitable technique. Alternatively, the end member of the support and the structural member or the end member of the support and an adjacent support may be fastened together by frictional engagement, or by providing complementary screw-threaded portions, press fittings, snap fit features, male-female connectors, or the like.

The connection portion of the end member of the support preferably comprises at least one aperture configured to allow a mechanical fastener to pass through the end member and secure the support to an end member of an adjacent support or to the structural member. The apertures may be of any suitable shape, size or configuration. However, it will be understood that the shape and size of the apertures may vary depending on a number of factors such as the type of mechanical fasteners to be used to attach the support to the structural member and the characteristics of the utility object to be attached. In use, the one or more mechanical fasteners may be passed through an aperture in the end member of the support and through a corresponding aperture in an adjacent support and/or the structural member.

The support for attachment to a structural member may further comprise a lower member. The lower member may be associated with one or more surfaces of the receiving portion of the support. It is envisaged that, in use, the lower member may facilitate the bracing of the pair of side members at a lower portion of the support. In an embodiment of the invention, at least a portion of the lower member of a support may at least partially extend into the receiving portion of the support. In this instance, a portion of the lower member may abut the portion of the structural member retained by the receiving portion of the support.

In embodiments of the invention in which a lower member is present, it is envisaged that the end member may be positioned so as to abut at least a portion of a first surface of the portion of the structural member received in the receiving portion. Similarly, the lower member may be positioned so as to abut at least a portion of an opposed second surface of the portion of the structural member received in the receiving portion.

In some embodiments of the invention, the utility object may be adapted for connection directly to the support. In an alternative embodiment of the invention, the utility object may be adapted for connection to the support via a secondary support. In this embodiment, it is envisaged that the secondary support may be adapted to the support, and the utility object may be adapted for connection to the secondary support.

The secondary support may be of any suitable form. For instance, the secondary support may be a pipe support, a cleat, a clip, a hanger, a strut, a clamp, a bracket, a bend support, an electrical tray, a unistrut, and the like. Thus, the secondary support may be adapted to support and/or retain the utility object.

The utility object may be of any suitable form. However, it is envisaged that the utility object may comprise conduits including pipes (such as those carrying air, water, processed liquids, gas, sewage and the like) and hoses, cables (such as electricity, fibre optic, data, telephone or instrument cables), light fittings, and the like.

The present invention provides a number of advantages over the prior art. For instance, the present invention improves ease of use and cost-efficiency by providing quick installation and removal of building infrastructure to and from structural members with no site welding, drilling or grinding of building infrastructure. In addition, the present invention provides the advantage that the painted surfaces of the structural member are not damaged which can avoid later corrosion of unpainted metal surfaces. The present invention improves safety to construction workers working in the presence of atmospheric volatile substances by providing a weldless construction method. In addition, the present invention provides improved safety during installation and removal of building infrastructure to and from structural members.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a side view of an embodiment of the invention in the form of a support for attachment to a structural member in the form of an I-beam;

FIG. 2 shows an end view of the support according to an embodiment of the invention as shown in FIG. 1;

FIG. 3 shows a side view of an end member for a support according to the embodiment of the invention as shown in FIG. 1;

FIG. 4 shows a side view of an embodiment of the invention in the form of a support for attachment to a structural member in the form of a C-shaped channel structural member;

FIG. 5 shows a side view of an embodiment of the invention in the form of a support for attachment to a structural member in the form of an angle iron; and

FIG. 6 shows an end view of the support according to the embodiment of the invention as shown in FIG. 5.

### DESCRIPTION OF THE EMBODIMENTS

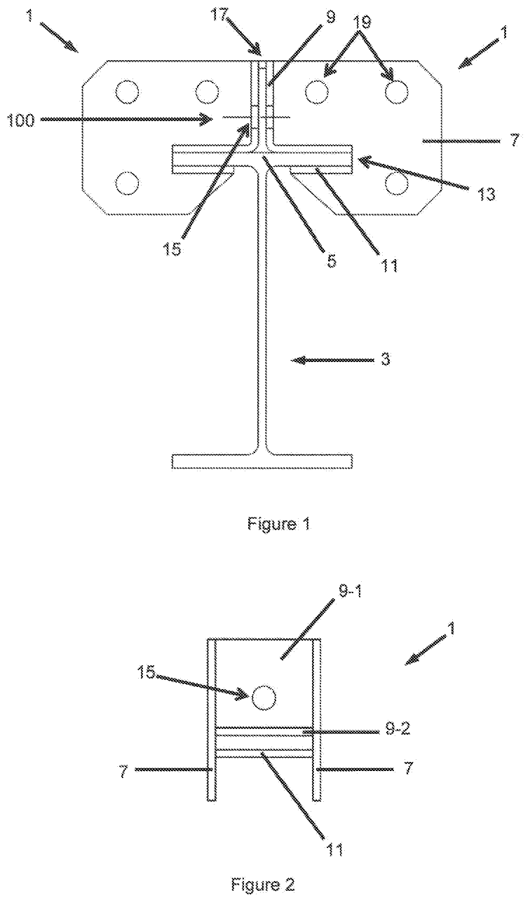

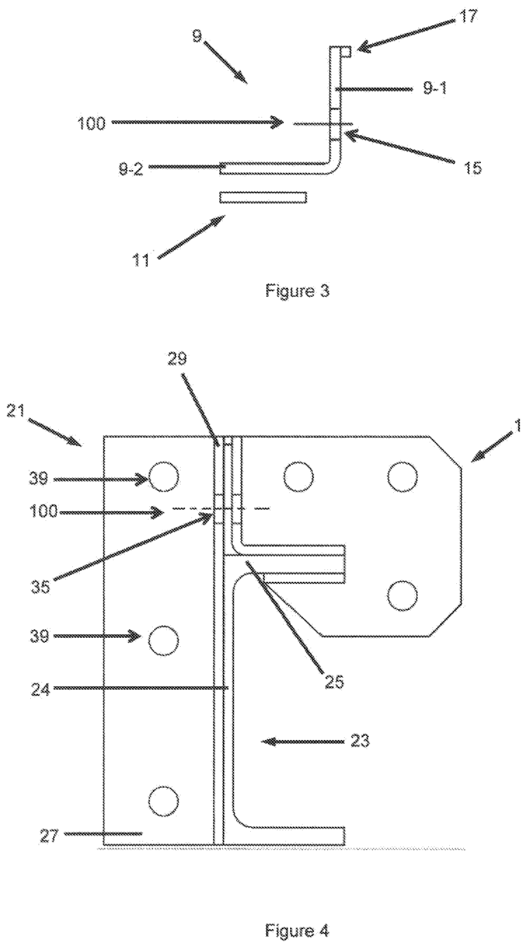

Referring to FIGS. 1-3, in an embodiment of the invention, a support for attachment to a structural member in the form of an I-beam is generally indicated by arrow 1. In FIG. 1, a pair of supports 1 is shown fixed to opposing ends of a flange 5 of I-beam 3. In FIG. 2, an end view of support 1 is shown. In FIG. 3, a side view of end member 9 and lower member 11 is shown. Support 1 comprises a first side member 7 and a second opposed side member (not shown), an end member 9 and a lower member 11. When assembled, support 1 comprises a receiving portion 13 configured to receive an end of flange 5.

End member 9 of support 1 is in the form of an L-shaped bracket and comprises two portions 9-1 and 9-2 at substantially right angles to one another. A first portion 9-1 of end member 9 forms an end wall for support 1 and a second portion 9-2 of end member 9 abuts an upper surface of the flange 5 of the structural member 3. A protruding lip 17 associated with first portion 9-1 of end member 9 allows abutment and placement of the end member 9 with respect to a surface of the structural member (not shown) or an adjacent support (not shown). It is envisaged that in use, this configuration substantially precludes movement of the support 1 relative to the I-beam 3 or an adjacent support. The first portion 9-1 of end member 9 comprises an aperture 15 for a mechanical fastener to pass through the end member 9 of support 1 and at least partially through the end member of an adjacent support in the direction indicated by line 100.

Side member 7 comprises at least one aperture 19 configured to allow a mechanical fastener (not shown) to pass through and secure a secondary support (not shown) for a utility object (such as a water pipe, electricity cable) to the side member of support 1. The secondary support is selected from the group consisting of: pipe support, cable cleat, light bulb, strut or airline support and the utility object is selected from the group consisting of: pipe, cable, light fitting or air-line.

In use, a support 1 can be positioned with respect to an end of a flange 5 of a structural member 3 by receiving the end of the flange in the receiving portion 13 of the support 1. The support 1 is then clamped to the structural member 3 by passing a mechanical fastener in the form of bolt through the aperture 5 of the end member 9 and through the aperture of the end member of an adjacent support and fixing the end members together with a nut. A secondary support for a utility object (not shown) is then fixed to the side member 7 of the support 1 by passing a mechanical fastener such as a bolt through aperture 9 of the side member and an aperture of the adjacent side member of the support 1. Adjacent side members 7 of the support 1 are then fixed together with a nut.

In FIG. 4, a pair of dissimilar supports for a C-shaped channel member is shown. Support 1 is essentially as described in FIGS. 1-3 and is fixed to an end of a flange 25 of C-shaped channel member 23. Support 21 is fixed to the web 24 of C-shaped channel member 23. Support 21 comprises a first side member 27 and a second opposed side member (not shown) and an end member 29. End member 29 of support 21 is a substantially planar structure, such as a flat bracket. End member 29 comprises an aperture 35 for a mechanical fastener to pass through the end member 29 of support 21 and at least partially through the end member of adjacent support 1 in the direction indicated by line 100. End member 29 may comprise a protruding lip.

Side member 37 comprises at least one aperture 39 configured to allow a mechanical fastener (not shown) to pass through and secure a secondary support (not shown) for a utility object such as a water pipe, electricity cable, to the side member of support 30. The secondary support is selected from the group consisting of: pipe support, cable cleat, light bulb, strut or airline support and the utility object is selected from the group consisting of: pipe, cable, light fitting or air-line.

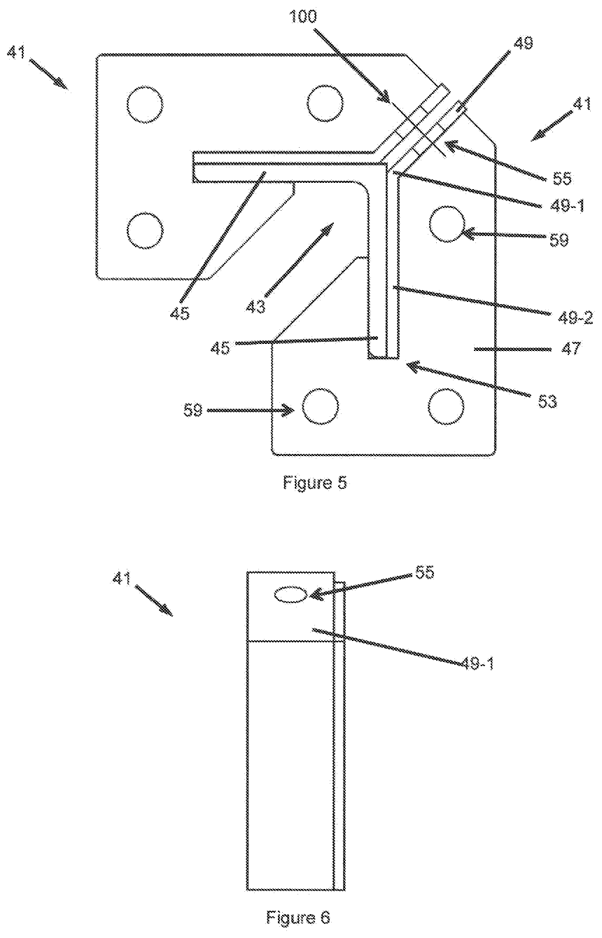

Referring to FIGS. 5 and 6, in an embodiment of the invention, a support for attachment to a structural member in the form of an angle iron is generally indicated by arrow 41. In FIG. 5, a pair of supports 41 is shown fixed to opposing ends 45 of angle iron 43. In FIG. 6, an end view of support 41 is shown. Support 41 comprises a first side member 47 and a second opposed side member (not shown) and an end member 49. When assembled, support 41 comprises a receiving portion 53 configured to receive an end 45 of angle iron 43.

End member 49 of support 41 comprises two portions 49-1 and 49-2 at an obtuse angle to one another, wherein a first portion 49-1 forms an end wall for support 41 and a second portion 49-2 of the end member 49 abuts an upper surface of the flange 45 of the structural member 43. The first portion 49-1 of end member 49 comprises an aperture 55 for a mechanical fastener to pass through the end member 49 of support 41 and at least partially through the end member of an adjacent support in the direction indicated by line 100.

Side member 47 comprises at least one aperture 59 configured to allow a mechanical fastener (not shown) to pass through and secure a secondary support (not shown) for a utility object such as a water pipe, electricity cable, to the side member of support 41. The secondary support is selected from the group consisting of: pipe support, cable cleat, light bulb, strut or airline support and the utility object is selected from the group consisting of: pipe, cable, light fitting or air-line.

In use, a support 41 can be positioned with respect to an end of a flange 45 of a structural member 43 by receiving the end of the flange in the receiving portion 53 of the support 41. The support 41 is then clamped to the structural member 43 by passing a mechanical fastener in the form of bolt through the aperture 55 of the end member 49 and through the aperture of the end member of an adjacent support and fixing the end members together with a nut. A secondary support for a utility object (not shown) is then fixed to the side member 47 of the support 41 by passing a mechanical fastener such as a bolt through aperture 59 of the side member and an aperture of the adjacent side member of the support 41. Adjacent side members 47 of the support 41 are then fixed together with a nut.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A support for attachment to a structural member comprising:
a pair of side members;
a receiving portion located in each of the pair of side members configured to receive a portion of the structural member; and
an end member, wherein the end member includes a connection portion configured to facilitate connection of the end member to an adjacent support,
and wherein at least one of the pair of side members comprises a connection portion configured to facilitate connection of a utility object thereto.
